(19) United States
(12) Patent Application Publication
(10) Pub. No.: US 2020/0361515 A1
(43) Pub. Date: Nov. 19, 2020

(54) STEERING COLUMN SUPPORT CONTAINING GUIDANCE OF THE DEFORMABLE IMPACT-ABSORBING LEAVES

(71) Applicant: JTEKT EUROPE, Irigny (FR)

(72) Inventor: Clément THIVIN, Lyon (FR)

(73) Assignee: JTEKT EUROPE, Irigny (FR)

(21) Appl. No.: 16/960,766

(22) PCT Filed: Jan. 4, 2019
(86) PCT No.: PCT/FR2019/050015

§ 371 Date: Jul. 8, 2020

(30) Foreign Application Priority Data
Jan. 9, 2018 (FR) 18/50172

(51) Int. Cl. B62D 1/19

(52) U.S. Cl. CPC B62D 1/195

(57) ABSTRACT

A steering column support for a motor vehicle intended to absorb energy during an impact backward on this column, this support including at least one deformable leaf ensuring fastening thereof on a cross-member of the vehicle body, this at least one leaf including two parallel portions connected by a 180° curved folding, being fitted between two guide faces forming a channel holding the spacing between these two portions, for each leaf the support includes a guide sheet metal folded at 180°, having inside the fold two parallel faces forming the guide faces.

The present invention concerns a steering column support for a motor vehicle intended to absorb energy during a frontal impact, as well as a motor vehicle equipped with such a column support.

Motor vehicles include a steering system comprising a steering column receiving at its end a maneuvering wheel, connected forwards the vehicle to a steering case carrying out pivoting of the front steered wheels of the vehicle.

Regarding the steering column, by convention, the side of the steering wheel turned rearwards the vehicle, is called front side.

The rear portion of the steering column is inserted into a sheath held by a column support fastened under a rigid cross-member of the vehicle body, passing behind the dashboard, in order to ensure holding and guidance of this column.

The column support may include a device for vertical adjustment of the position of the sheath, comprising a blocking lever enabling the driver to loosen this blocking in order to adjust the height of the steering wheel.

The steering wheel usually includes an air cushion to protect the driver, called «airbag», receiving the driver's force projected forward the vehicle by dampening it in case of impact on this front of the vehicle, which transmits this force to the column support.

A known type of a steering column support, presented in particular by the document US-A1-20120273291, includes a connection between this support and the cross-member, comprising on each side of the column a deformable metal leaf enabling, by its progressive deformation, a movement of the support backward of the column along its axis when a force is applied on the steering wheel. The two leaves carry out high energy absorption in order to dampen the impact.

The top of the support forms a plane parallel to the axis of the steering column, fastened beneath the cross-member. Each leaf includes two parallel portions connected backward of the column by a 180° curved folding, comprising an upper portion disposed in the plane of the support, whose end is directly fastened flat on the cross-member by a screw. The end of the lower portion disposed beneath the first portion, includes a fold forming an attachment point on the support.

For each deformable leaf, two guide parts having each a face parallel to the other, form a guide channel between these faces fittedly receiving the curved leaf thereinside to hold the spacing between its two portions during a deformation of this blade.

A rearward impact on the support during an accident leads the lower portion of the leaf to slide backwards. The guidance of the channel imposing a constant spacing between the two portions of the blade, the 180° curved folding is progressively displaced along this leaf while extending the upper portion and while reducing the lower portion.

A controlled uncoiling of the deformable leaf which absorb energy in a progressive and regular manner with a plastic deformation, can be obtained starting from a force threshold, which dampens the impact of the driver on the airbag limiting the acceleration force suffered thereby.

The two faces of the guide channel are subjected to a considerable expansion pressure during the deformation of the leaf. The problem that arises is that the two parts forming these two faces as well as the connection between these two parts, which may be achieved in particular by welding, must have a significant stiffness to ensure the proper guidance of the blade, which requires some space and generates costs. The number of parts also increases the costs.

The present invention aims in particular at avoiding these drawbacks of the prior art.

To this end, it provides a steering column support for a motor vehicle intended to absorb energy during a rearward impact on this column, this support comprising at least one deformable leaf ensuring fastening thereof on a cross-member of the vehicle body, each leaf including two parallel portions connected by a 180° curved folding, being fitted between two guide faces forming a channel holding the spacing between these two portions, this support being remarkable in that for each blade, it includes a guide sheet metal folded at 180°, having within the fold two parallel faces forming the guide faces.

An advantage of this column support is that the guide sheet metal directly forming the guide channel receiving the deformable curved leaf between its two parallel faces, achieve in a simple and cost-effective manner a very rigid guidance of this blade, requiring no connections or adjustments between two different parts to form these two faces of this guidance.

The column support according to the invention may further include one or more of the following features, which may be combined together.

Advantageously, the support includes one single guide sheet metal ensuring the connection with the vehicle body, comprising on each side a 180° fold to form two guide channels of two leaves each disposed on one side of the steering column.

Advantageously, each guide channel receives a rear face disposed transversely, partly closing this channel, on the rear face the end of the leaf rests in this channel connected to the support. Thus, a rigid bearing connected to the support on an end of the leaf transmitting the force in case of impact, is formed.

Advantageously, the rear face includes a slot receiving in a fitted manner the leaf passing through this face. This slot ensures an accurate guidance of the leaf sliding therein.

Advantageously, the support includes on each side of the steering column a rear face, these two faces being formed in the same sheet metal.

Advantageously, for each blade, the guide sheet metal folded at 180° includes an extent coming behind the rear face.

Advantageously, the 180° fold of the guide sheet metal is formed on the extent, parallel to the axis of the steering column.

Advantageously, for each blade, its end fastened to the cross-member of the vehicle, includes a spacer having a thickness larger than the overall thickness of the leaf with its folding.

Advantageously, the rear side of the spacer has a «V» shape fitted in a complementary shape cut in a support sheet metal in the normal driving position. This V shape ensures an accurate wedging of the support in the normal driving position.

Advantageously, each leaf includes a frangible connection with the cross-member of the vehicle, breaking above a force threshold on the steering column.

In this case, in particular, the frangible connection may include rivets successively passing through a connecting sheet metal, the guide sheet metal and the spacer.

The invention also relates to a motor vehicle including a steering column equipped with a column support comprising any one of the preceding features.

Other features and advantages of the present invention will appear on reading the detailed description hereinafter, of a non-limiting example of implementation, made with reference to the appended figures in which:

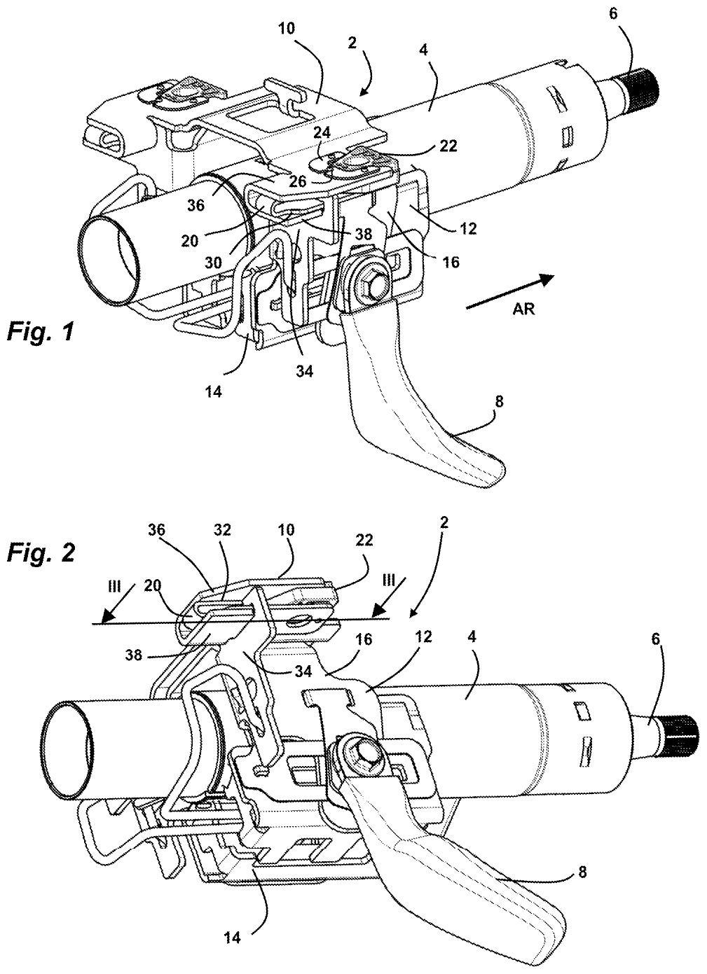

FIGS. 1 and 2 present a steering column support according to the invention according to two different views in a normal driving position, with its column guide sheath;

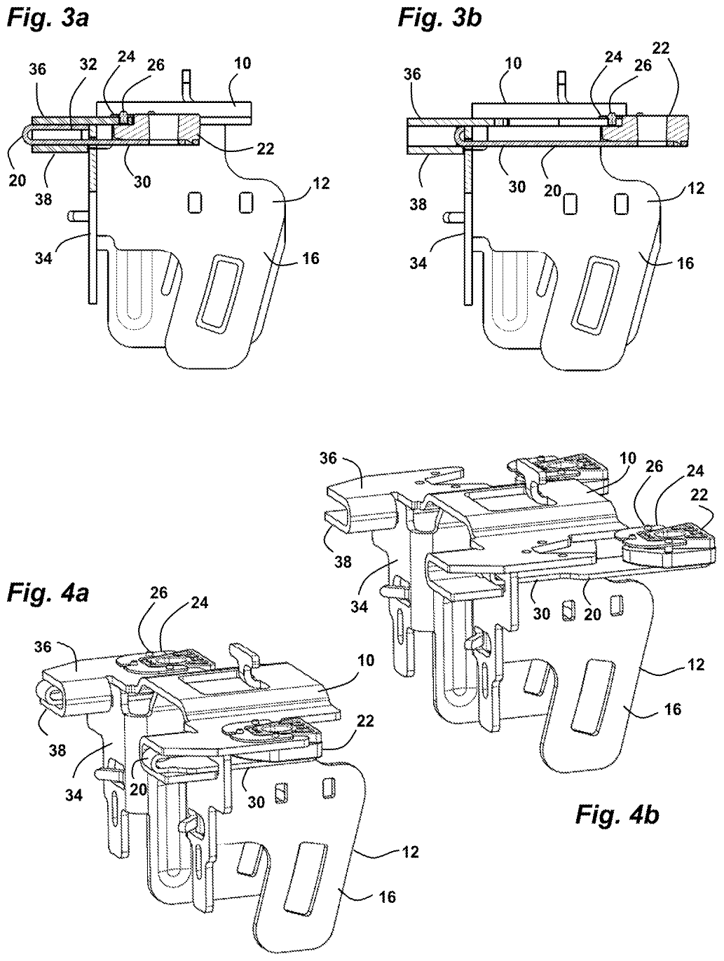

FIGS. 3a and 3b are a sectional view according to the section plane III-III, of the upper sub-assembly of the support successively in a normal position and in a deformed position after an impact on the steering wheel; and

FIGS. 4a and 4b present in perspective this upper sub-assembly successively in a normal position and in a deformed position.

FIGS. 1, 2, 3a and 4a present a support 2 containing thereinside a sheath 4 guiding a steering column 6 disposed along a longitudinal axis, receiving a non-represented steering wheel at the front side of the column indicated by the arrow AV.

The direction of the vehicle may include an electric power system, generating a complementary force as that provided by the driver to maneuver the steered wheels.

The support 2 includes a lower sub-assembly 14 supporting the sheath 4, comprising a support sheet metal 18 welded to this sheath 4, connected to an upper sub-assembly by slides parallel and perpendicular to the column axis, comprising a blocking lever 8 in order to adjust its position in depth and in height depending on the needs of the driver.

In this example, the upper sub-assembly of the support 2 is symmetrical with respect to a vertical plane passing through the axis of the steering column 6. The external sides of the support 2 are defined with respect to this vertical plane, away from this plane.

The upper sub-assembly of the support 2 includes a top sheet metal 10 substantially forming a plane parallel to the axis of the steering column, receiving a bottom sheet metal 12 therebelow.

The bottom sheet metal 12 includes two wings 16 parallel to one another, disposed on each side of the sheath 4 while covering the support sheet metal 18, comprising the slides enabling the height adjustment, and comprising two rear faces 34 perpendicular to the axis of the column.

Each side of the support 2 includes a deformable leaf 20 ensuring the connection between this support and a cross-member disposed under the dashboard of the vehicle, these leaves being symmetrically disposed with respect to the axis of the column so as to evenly distribute the forces on the two leaves.

Each leaf 20 includes two parallel portions connected to one another by a 180° curved folding turned rearwards, disposed parallel to the plane of the top sheet metal 10.

The lower portion 30 of the leaf 20 has at its front end a drilling receiving thereabove a spacer 22 made by molding of a plastic material, enabling the introduction of a screw from below which is fastened in a piercing of the cross-member of the vehicle body.

A connecting sheet metal 24 placed on the top sheet metal 10, connects this top sheet metal to the spacer 22 thanks to two rivets 26 coming from above, transversally aligned, successively passing through the connecting sheet metal, the top sheet metal and the spacer. The rivets 26 ensure the blocking of the sliding of the column below a peak force, above this peak, they shear allowing for the deformation of leaves 20.

The rear side of the spacer 22 has a «V» shape fitted in a complementary shape cut in the top sheet metal, so as to obtain an accurate and stable wedging of the support 2 with respect to the cross-member of the vehicle receiving theses spacers in the normal driving position.

On each side of the support 2, the rear edge of the wing 16 of the bottom sheet metal 12 extends beyond a folding turned outwards, by the rear face 34 perpendicular to this web.

The upper portion 32 of the leaf 20 terminates in a front end bearing on the rear face 34, including a lug projecting forwardly, fitting in a drilling of this rear face in order to ensure its bearing and its positioning on this face. In this manner, a weld usually carried out to fasten the end of the deformable leaf 20 on a transverse face of the support is avoided.

The top sheet metal 10 of the support 2 includes on each side an extent portion 36 flush with the upper edge of the rear face 34, the bottom of this extent forming a guide upper face.

The extent portion 36 has on the inside a folding parallel to the longitudinal axis, downward according to a 180° angle, in order to obtain a guide lower face 38 which is opposite the parallel guide upper face. With these two faces formed on a support sheet metal, a guide channel fittedly receiving a deformable leaf 20 is obtained without adding any additional part, to impose a constant height between the two portions 30, 32 of this curved blade.

In the normal operating position, the rear end of the lower portion 30 of the leaf 20 with its spacer 22 lies just behind the rear face 34 of the support 2.

The guide channel is made in a simple and cost-effective manner on each side by a simple folding of the same existing top sheet metal 10, disposed on top the support 2, which avoids connections between two guide faces constituted by two different parts, which would require both a good accuracy of positioning with respect to each other, and a high resistance.

In addition, a welding of each leaf 20 on the support 2 is avoided thanks to its end lug turned forwards, fitting into a drilling of the rear face 34 so to ensure positioning thereof.

FIGS. 3b and 4b illustrate the support 2 after an impact on the steering wheel having led to the advance of the sheath 4 and of this support.

For a driver's impact on the steering wheel generating a peak of the axial force on the column that is not too high, lower than a threshold in the range of 4500 to 6000N, the rivets 26 resist, the column does not advance.

For a peak force higher than the threshold, the rivets 26 shear, then the leaves deform under a constant force lower than this threshold, in the range of 2500 to 4000N, with a regular energy absorption. On each side, the rear face 34 of the support 2 has pushed on the front end of the upper portion 32 of the leaf 20.

The two portions 30 and 32 of the leaf 20 being guided by the guide channel, and the lower portion 30 being retained by the screw fastened on the cross-member of the vehicle, the upper portion 32 is obliged to advance parallel to itself, with a progressive deployment of the curved folding which is displaced along this blade.

At the end of the advance of the sheath 4 depicted in these figures, a very short upper portion 32 of the leaf 20, including only the 180° curved folding, is obtained with the support 2 abutting on the cross-member of the vehicle. The two leaves 20 have absorbed a maximum energy during this displacement.

It should be noted that a minimum force must be applied on the steering wheel to start deforming the leaves 20, a slight impact thereon has no effect, which avoids changing the support 2 when repairing the vehicle.

1. A steering column support for a motor vehicle intended to absorb energy during an impact backward on this column, this support comprising at least one deformable leaf ensuring fastening thereof on a cross-member of the vehicle body, this at least one leaf including two parallel portions connected by a 180° curved folding, being fitted between two guide faces forming a channel holding the spacing between these two portions, wherein for each leaf the support includes a guide sheet metal folded at 180°, having inside the fold two parallel faces forming the guide faces.

2. The column support according to claim 1, wherein it includes one single guide sheet metal ensuring connection with the vehicle body, comprising on each side a 180° fold to form two guide channels of two leaves each disposed on one side of the steering column.

3. The column support according to claim 1, wherein each guide channel receives a rear face transversally disposed, partly closing this channel, on which the end of the leaf bears in this channel connected to the support.

4. The column support according to claim 3, wherein the rear face includes a slot receiving in a fitted manner the leaf passing through this face.

5. The column support according to claim 3, wherein it includes a rear face on each side of the steering column, these two faces being formed in a same sheet metal.

6. The column support according to claim 3, wherein for each leaf the guide sheet metal folded at 180° includes an extent coming behind the rear face.

7. The column support according to claim 6, wherein the 180° fold of the guide sheet metal is formed on the extent, parallel to the axis of the steering column.

8. The column support according to claim 1, wherein for each leaf its end fastened at the cross-member of the vehicle, includes a spacer having a thickness larger than the overall thickness of the leaf with its folding.

9. The column support according to claim 8, wherein the rear side of the spacer has a «V» shape adjusted in a complementary shape cut in a support sheet metal in the normal driving position.

10. The column support according to claim 1, wherein each leaf includes a connection with the cross-member of the vehicle breaking above an effort threshold on the steering column.

11. The column support according to claim 8, wherein the frangible connection includes rivets successively passing through a connecting sheet metal, the guide sheet metal and the spacer.

12. A motor vehicle including a steering column equipped with a column support, wherein this column support is according to claim 1.
